(19) United States
(12) Patent Application Publication
(10) Pub. No.: US 2019/0084253 A1
(43) Pub. Date: Mar. 21, 2019

(54) Extrudable Composition and Product Having Abrasive Surface

(71) Applicant: Oak Enterprises, LLC, Oklahoma City, OK (US)

(72) Inventors: Mark Leonard Solecki, Moore, OK (US); Anthony J. Gordon, Mcloud, OK (US); Elmira Dindari, Houston, TX (US)

(73) Assignee: Oak Enterprises, LLC, Oklahoma City, OK (US)

(21) Appl. No.: 16/136,762

(22) Filed: Sep. 20, 2018

Related U.S. Application Data
(60) Provisional application No. 62/560,995, filed on Sep. 20, 2017.
(60) Provisional application No. 62/703,430, filed on Jul. 25, 2018.

(51) Int. Cl. B29C 70/64; B29C 47/00; B29C 47/78; B29C 47/80; B29C 47/88; C08J 9/32

(52) U.S. Cl. CPC B29C 70/64; B29C 47/0004; B29C 47/0085; B29C 47/786; B29K 2023/065; B29C 47/8895; C08J 9/32; B29K 2995/0072; B29C 47/802

(57) ABSTRACT

An extruded thermoplastic product having a surface abrasive to insects. The extruded product is formed from a dry powder composition being comprised of a thermoplastic polymer, a plurality of pelletized diatomaceous earth, and a plurality of expandable microballoons. The composition is mixed and heated in an extrusion machine before being forced into a die of selected profile. Cooling the material immediately after being removed from the die allows the diatomaceous earth to remain at the surface of the material. The material with the surface abrasive to insects is used is used as a component in a product, such as conventional weatherization products, for placement in a building opening that insects use as ingress to the building. Products contemplated for use with the extrusion include door sweeps, door and window seals, and thresholds.

### FIELD OF THE INVENTION

The present invention relates generally to extrudable compositions and more particularly to extrudable weatherization products made from compositions having abrasive fillers such as diatomaceous earth or other bug repellent components.

### SUMMARY OF THE INVENTION

The present invention is directed to an extrudable dry powder composition. The composition comprises a pelletized abrasive structural filler, a mechanical blowing agent, and a thermoplastic polymer. The pelletized abrasive structural filler is pelletized diatomaceous earth. The mechanical blowing agent is pelletized microballoons.

In an alternative embodiment, the present invention is directed to an extruded plastic weatherization product. The extruded product comprises an attachment surface adapted to be attached to a surface of a building opening, and an insect abrasion component connected to the attachment surface and extending from the attachment surface. The insect abrasion component comprises a thermoplastic extruded from a dry powder composition comprising a thermoplastic polymer, a plurality of pelletized diatomaceous earth, and a plurality of expandable microballoons.

In yet another embodiment, the present invention is directed to a method of a method of exposing diatomaceous earth at the surface of an extruded thermoplastic. The method comprises the steps of mixing an extrudable dry powder compound, extruding the compound through a die to create a shaped product, and cooling the product after it is removed from the die. The dry powder compound comprises a thermoplastic polymer, pelletized diatomaceous earth, and a mechanical blowing agent. The mechanical blowing agent used comprises expandable microballoons.

### BRIEF DESCRIPTION OF THE DRAWINGS

FIG. 1 is a schematic illustration of a system for extruding thermoplastic products in accordance with the present invention.

FIG. 2 is an illustration showing distribution of filler material in an extrudable composition made in accordance with the present invention.

FIG. 3 is an illustration showing distribution of filler material in an extruded product made in accordance with the present invention.

FIG. 4 is a door sweep weatherization product resulting from the composition and process of the present invention.

FIG. 5 is a garage door bottom product resulting from the composition and process of the present invention.

FIG. 6 is an illustration of a method for coating an article in accordance with the present invention.

### DETAILED DESCRIPTION

The present invention defines compositions and procedures for producing an extruded thermoplastic product featuring the presence of bug repellent materials in or applied to the extruded product. The present invention is advantageous in keeping insects out of inhabited places such as personal residences and commercial businesses without the need for traditional chemical barriers that have the potential to do harm to the environment, water, indigenous foliage, pets, and children. With products made in accordance with the present invention, such as weatherstripping for doors or windows, extruded thermoplastics contain an abrasive environmentally safe material that will kill bugs that come in contact with the product.

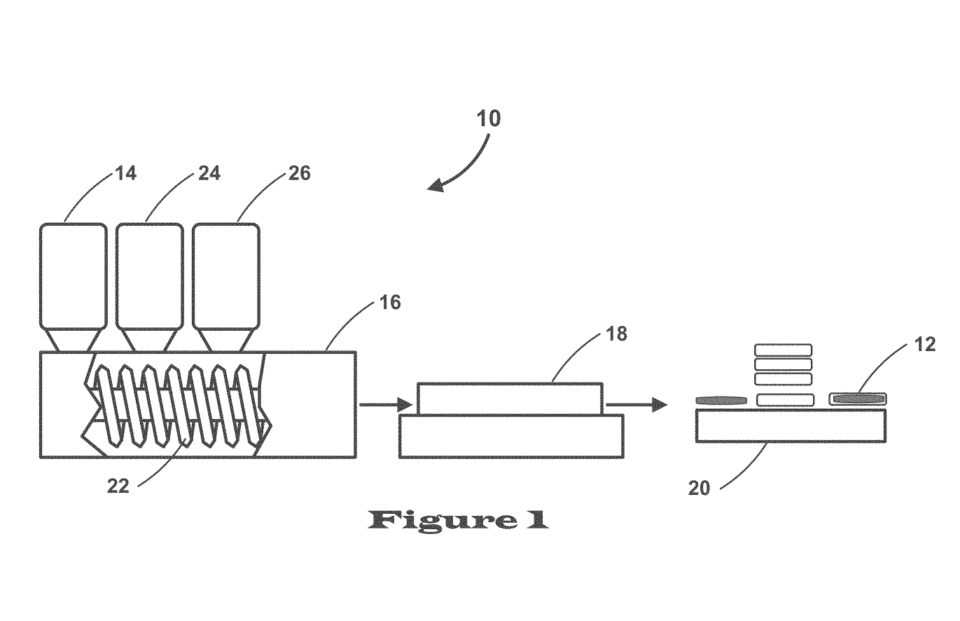

With reference now to the drawings and to FIG. 1 in particular, there is shown therein a system, designated by reference numeral 10, for extruding a product 12 in accordance with the present invention. The extrusion system 10 comprises a primary feeder 14, an extruder 16, a chiller 18, and an optional cutter/packager 20. The primary feeder 14 allows for extrudable materials to be added to the system 10 as needed. The feeder 14, or hopper, preferably allow for extrudable materials to be metered into the system in desired measurable amounts. Extrudable materials, as will be discussed below, may be powders, pellets, or other known material forms. The extruder 16 will preferably comprise a screw auger 22 for mixing and advancing the extrudable materials, heating elements, and one or more dies or molds for shaping the product. The chiller 18 is preferably a water bath the product can be fed through after exiting the die. The optional cutter 20 allows for product 12 to be cut, sized, or packaged as desired. In the preferred embodiment, the system 10 further comprises a first additive feeder 24 and a second additive feeder 26. The first feeder 24 and the second feeder 26 allow for materials such as structural fillers, blowing agents, or colorants to be added to the extruded material. In the preferred embodiment, the first feeder 24 and the second feeder 26 allow materials to be added at a metered flow rate to manage the amount of material added to the material to be extruded.

The extrusion system 10 is used in the present invention to create an extruded product that contains in its matrix or has attached to its surface an abrasive material such as aluminum oxide or diatomaceous earth. The present invention contemplates a new extrudable dry powder composition for use in the extrusion process. The preferred embodiment for the dry powder composition is different from conventional extrudable material in that it uses expandable microspheres or microballoons to drive the abrasive filler material to the surface of the extruded product.

Preferably, the extrudable dry powder composition comprises a polymer, an abrasive structural filler, and a mechanical blowing agent. More preferably, the polymer will comprise a thermoplastic polymer. Most preferably, the thermoplastic polymer will comprise polyvinyl chloride or high-density polyethylene. One skilled in the art will appreciate that extrudable compositions often include additives to affect density or structural strength.

In the preferred embodiment, the abrasive structural filler in the dry powder composition will comprise diatomaceous earth (“D.E.”). Alternatively, other abrasive fillers such as boron nitride, aluminum nitride, or aluminum oxide. Preferably, the D.E. will be pelletized to protect the D.E. from moisture and to allow the D.E. to be more usable in the extrusion system 10. One skilled in the art will appreciate the D.E. may be in the form of a coarse powder that will absorb moisture or be corrosive to extruder machinery, and pelletizing the D.E. in a conventional known manner will allow the D.E. to be successfully used in the extrusion system 10. As an alternative to pelletization, bee's wax may be used to mix with the dry powder D.E. to help with processing the D.E. in the system 10.

The mechanical blowing agent of the dry powder composition will preferably comprise expandable microspheres or microballoons. Alternatively, other mechanical blowing agents such as chopped glass fiber, graphite, or carbon fiber may be used for structural stability.

One skilled in the art will appreciate that microballoons have been used advantageously as a foaming agent or filler in conjunction with polymers as plastics. The present invention takes advantage of the characteristics of the expandable microballoons to bring the D.E. to the surface of the extruded thermoplastic as will be described below.

Preparation of the dry powder compound requires considered selection of ratios of the polymer, the abrasive filler in the form of pelletized D.E., and the mechanical blowing agent to achieve benefits described herein. Additionally, it is preferred to have each of the components of the compound be pelletized. Factors in the selection of ratios include, but would not be limited to, weight percentage of pelletized D.E., the desired profile thickness of the extruded product, and extrusion machine parameters.

The dry powder composition, in the ratios desired, can then be used for extrusion into a desired product. In the process of the present invention, the components of the dry powder composition are measured as desired and mixed together. In the preferred embodiment, the mixing of the composition components is accomplished through the rate controlled feeders of the extrusion system 10. While mixed, the compound is heated to melt the components of the composition into a molten slurry. The molten slurry is then flow injected into a die having a desired profile. When the product exits the die, the product is cooled by insertion in or being pulled through a water bath. One skilled in the art will appreciate the rate of cooling of the thermoplastic product will contribute to the final form and structure of the product. In the preferred embodiment of the present invention, cooling is preferably done immediately after exiting the die to preserve the condition of the expandable microballoons and allow the D.E. to remain at the surface of the product.

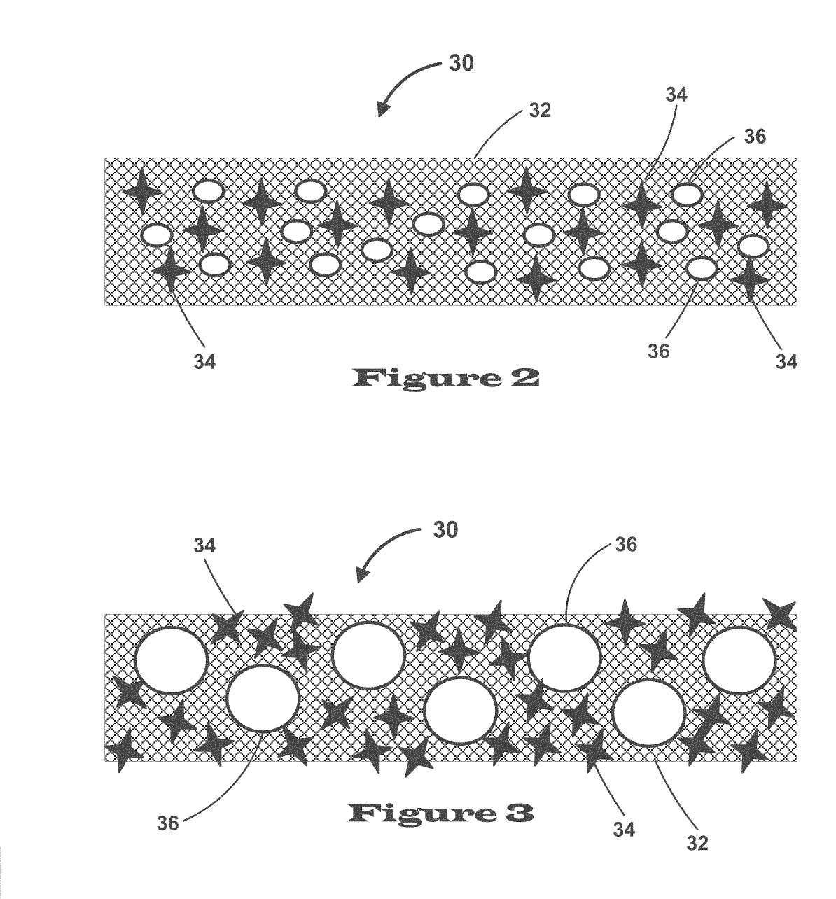

With reference now to FIGS. 2 and 3 there is shown therein a diagrammatic representation of a material 30 produced by the method of the present invention. As illustrated in FIG. 2, the material 30 is portrayed as the thermoplastic polymer 32 has been mixed with the abrasive filler material 34, the D.E., and the mechanical blowing agent 36, the expandable balloons. When mixed in the extruder 16 of FIG. 1, the material 30 comprises a relatively uniform distribution of the D.E. 34 and the microballoons 36 in the polymer 32. As one skilled in the art will appreciate, when material 30 is heated in the die the microballoons 36 expand forming void spaces in the material, lowering the density of the material and providing additional structural integrity. As portrayed in FIG. 3, the expansion of the microballoons 36 also forces the D.E. 34 to the surface of the material 30. Subsequent rapid chilling of the produced material 30 when it is removed from the die maintains the microballoons 36 in their expanded state and leaves the D.E. 34 at the surface of the produced form. If desired, the abrasive filler material 34 can be further exposed by lightly abrading the surface of the material 30.

Having the abrasive filler material 34 exposed at the surface of the material 30 provides an advantageous product for use in preventing insects from accessing areas of a home, business, or other interior space. Often weatherization products are used to seal gaps in building construction that insects use as an ingress to interior space. Weatherization products have an attachment surface adapted to be attached to a surface of a building opening, while another portion of the weatherization product extends from the attachment surface into the building opening. Conventional weatherization products, such as door sweeps, thresholds, insulating rope caulks, and weatherstripping, are regularly formed as extruded thermoplastics. The present invention contemplates use of the extruded material 30 as described herein as a component of weatherization products.

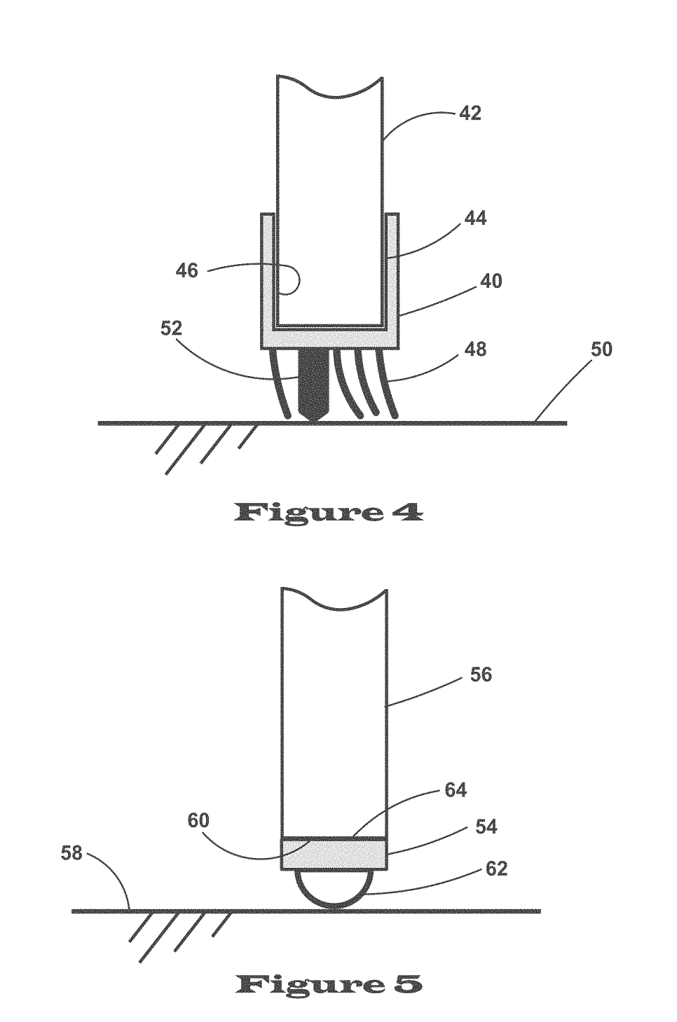

In a preferred embodiment of the present invention, extruded plastic weatherization products are modified to include at least one surface including the material prepared as discussed herein. Referring to FIG. 4, shown is a door sweep 40 for use on a door 42 for an entry way to a home or other building entry. The door sweep 40 comprises a door attachment surface 44 for securing the sweep to a base 46 of the door 42. The attachment surface adapted to be attached to the door or other surface of a building opening. Preferably the attachment surface 44 is formed to allow the door sweep 40 to slide on to the base 46 of the door 42 in a compression fit. Alternatively, the attachment surface 44 may be secured to the base 46 of the door 42 using an adhesive. The sweep 40 further comprises a plurality of fins 48 secured to the attachment surface 44 to bridge a gap between the door 42 and a floor 50. Preferably, at least one fin 52 of the door sweep 40 will comprise an insect abrasion component connected to the attachment surface and extending from the attachment surface. The insect abrasion component, or at least one fin 52, is prepared as described above such that the fin is comprised of extruded thermoplastic having expandable microballoons and the abrasive filler. More preferably, the abrasive filler used is D.E. Most preferably, all of the fins 52 of the door sweep 40 will be prepared as described herein.

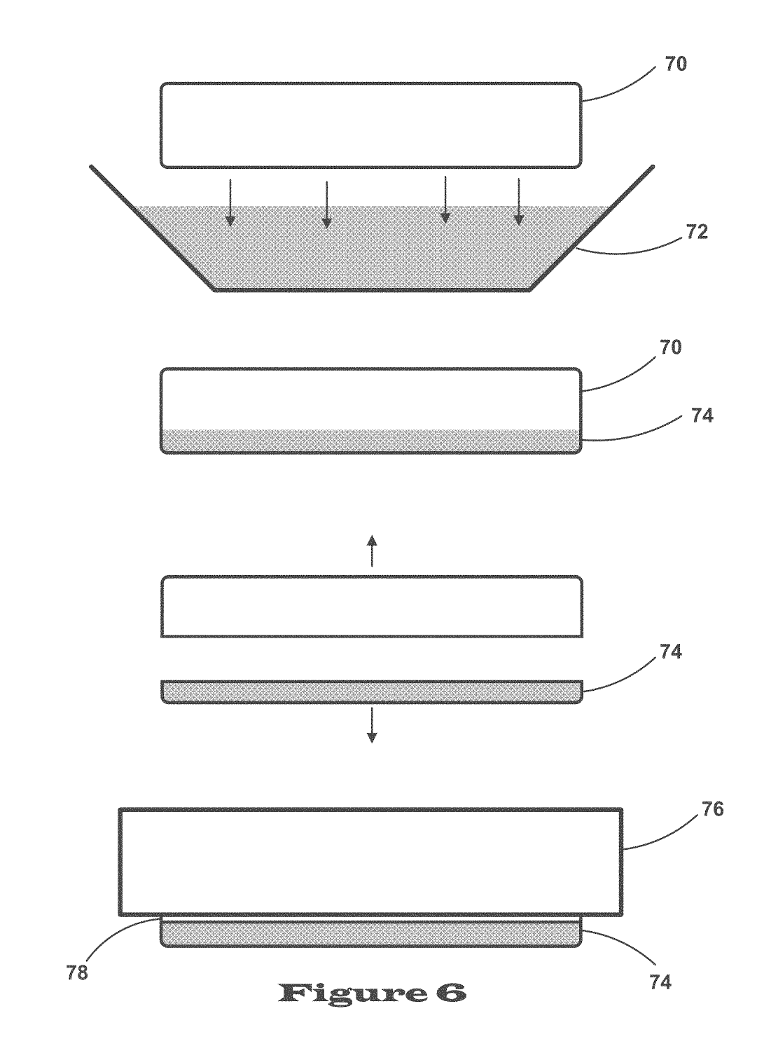

With reference to FIG. 5, shown therein is a transition product 54 for occupying space between a rigid garage door 56 and a floor 58. As shown herein, the transition product 54 comprises a conventionally known garage door bottom. Alternatively, the transition product 54 may be attached to an alternative building opening, such as a floor threshold or window sill. The transition product 54 comprises an attachment surface 60 and an insect abrasion surface 62. The attachment surface 60 is secured to a base 64 of the door 56, preferably using an adhesive integral to the attachment surface or a separately applied adhesive. The insect abrasion surface 62 is secured to the attachment surface 60 for positioning between the base 64 of the door 56 and the floor 58. Preferably the abrasion surface 62 of the garage door bottom 54 comprises a thermoplastic extrusion comprised of the dry powder composition as discussed herein. The abrasion surface 62 of the garage door bottom 54 is preferably created in a die in a useful profile form as illustrated or the like, and comprises the abrasive filler D.E. and the expandable microballoon used to drive the D.E. to the surface of the product. When either the transition product 54 of FIG. 5 or the door sweep 40 of FIG. 4 is in place on the respective door 56 or door 42, insects passing under the door will contact the abrasion surface 62 of the transition product 54 or the at least one fin 52 of the door sweep 40, exposing an exoskeleton of the insect to the D.E. on the surface of the product. As one skilled in the art will appreciate, an insect will die when the exoskeleton of the insect is abraded by D.E.

The dry powder composition of the present invention and the method of making a product incorporating the composition is further defined with the following example. A preferred extruded product is a door sweep having a fin with profile thickness of 1/32″. The dry powder compound prepared comprises by weight 50000 grams of pelletized polyvinyl chloride having a density of 1.38 gm/ml, 2150 grams of pelletized D.E. having a density of 0.50 gm/ml, and 550 grams of pelletized expandable microballoons having a density of 0.45 gm/ml. The pelletized D.E. is 40% by weight D.E. and the pelletized microballoons are 65% by weight Expancel microballoons. These ratios provide for composition with 94.88% by weight (86.77% by volume) of polyvinyl chloride, 4.08% by weight (10.30% by volume) of D.E., and 1.04% by weight (1.04% by volume) of microballoons. The powder components are blended and dried in a mixer, and then placed in a primary hopper for an extrusion machine. The machine used is a HPM Corp. Model #2.5 TMC injection molding machine. The machine is run with a melt temperature of 360 degrees, a screw speed of 13 RPM, a die temperature of 370 degrees, and a pull speed of 30 ft/min. One skilled in the art will appreciate the conditions of temperature and flow rate may be modified depending on the machine used and desired profile thickness of the product. The product is placed in the cool water bath immediately after being removed from the die. After being cooled, the product is presented for cutting and use as a weatherization product described above.

Additional formulations have been tested where the D.E. is not pelletized and bee's wax is used to encapsulate the D.E. for use in the extrusion system. Those formulations and trials illustrate initial attempts to identify weight percentages of 7% D.E. and 4% microballoons to produce a product having a profile thickness of ⅛″. These examples and formulations indicate for thinner profiles a formulation having 2% D.E. and 0.5% microballoons is appropriate.

In an alternative embodiment, the present invention may be formed as a topical coating applied to a desired product. The composition of polymer, abrasive structural filler, and mechanical blowing agent can be implemented as a coating by using excessive solvent in any of several basic coating formulations. In this this case, instead of driving the abrasive filler, or D.E., to the surface from within the matrix as described above, the D.E. will push through the surface of the material as the polymer recedes when the solvent in the formulation evaporates.

For preparation as a coating, consideration must be given to the type of substrate used and the polymer used for adhesion. In a preferred embodiment, a pressure sensitive adhesive may be used and would retain the surface exposure of the D.E. The substrate and adhesive used will determine wear ability and effectiveness. Preferably an open type structure, such as a felt or open cell foam, is used for the substrate for ease of application of the coating. Addition of a biodegradable adhesive, such as a polyol, would allow for gradual dispersion of the D.E. within the material of the substrate.

Turning now to FIG. 6, shown therein is a method for using the present invention to coat an article as described above. For use as a coating, a substrate 70 is first selected. Preferably, the substrate will be a foam or felt and may be presented as a roll of material. More preferably the material is ¼″ thick in a roll. The foam material substrate 70 then is placed in a composition solution 72, where the solution is comprised of the polymer, the D.E., the blowing agent, and an excess of solvent such as polyol. While in the solution 72, the material 70 and solution would need to be heated, preferably to a temperature of approximately 50° C. The heating process would result in the composition adhering to the material 70, with the polymer receding and the D.E. 74 left at the surface of the coated material. The portion of the coated material 70 having the D.E. 74 can then be separated from the roll. The D.E. coated material 74 is then available to be mechanically attached to a desired surface. As shown in FIG. 6, the D.E. coated material 74 is attached with an adhesive 78 to the base of a door 76 or window. Alternatively, the D.E. coated material 74 could be attached to a floor along a threshold or baseboard in a building structure.

Various modifications can be made in the design and production of the present invention without departing from the spirit thereof. Thus, while the principal preferred construction and use of the invention have been explained in what is now considered to represent its best embodiments, it should be understood that the invention may be practiced otherwise than as specifically illustrated and described, and claimed in the following claims.

What is claimed is:

1. An extrudable dry powder composition comprising:
a pelletized abrasive structural filler;
a mechanical blowing agent; and
a thermoplastic polymer.

2. The composition of claim 1 wherein the pelletized structural filler comprises pelletized diatomaceous earth.

3. The composition of claim 1 wherein the pelletized structural filler comprises pelletized boron nitride.

4. The composition of claim 1 wherein the thermoplastic polymer comprises polyvinyl chloride.

5. The composition of claim 4 wherein the thermoplastic comprises high-density polyethylene.

6. The composition of claim 1 wherein the blowing agent comprises expandable microspheres.

7. The composition of claim 1 wherein the pelletized structural filler comprises pelletized diatomaceous earth; and
wherein the blowing agent comprises pelletized expandable microballoons; and
wherein the ratio of diatomaceous earth to microballoons is 4:1.

8. The extrudable composition of claim 1 wherein the pelletized structural filler comprises pelletized diatomaceous earth; and
wherein the blowing agent comprises pelletized expandable microballoons; and
wherein the amount of thermoplastic comprises 94.88% by weight of the composition; and
wherein the amount of diatomaceous earth comprises 4.08% by weight of the composition; and
wherein the amount of expandable microballoons comprises 1.08% by weight of the composition.

9. A method of producing an extruded product using the compound of claim 1 comprising:
heating the compound into a slurry;
molding the slurry into a shape using a die;
solidifying the slurry in the die into a product; and
cooling the product in a water bath after the product is removed from the die.

10. The method of claim 9 in which the extrudable material comprises polyinyl chloride.

11. The method of claim 9 in which the product is cooled in the water bath immediately after the product is removed from the die.

12. The method of claim 9 wherein the extruded product comprises a door sweep.

13. The method of claim 9 wherein the extruded product comprises a transition product.

14. An extruded plastic transition product for use in a building opening, the product comprising:
an attachment surface adapted to be attached to a surface of a building opening; and
an insect abrasion component connected to the attachment surface and extending from the attachment surface;
wherein the insect abrasion component comprises a thermoplastic extruded from a dry powder composition comprising:
a thermoplastic polymer;
a plurality of pelletized diatomaceous earth; and
a plurality of expandable microballoons.

15. The product of claim 14 wherein the product is a door sweep and wherein the insect abrasion component comprises a fin of the door sweep.

16. The product of claim 14 wherein the product is a garage door bottom and the insect abrasion component comprises a semi-circular surface.

17. A method of exposing diatomaceous earth at the surface of an extruded thermoplastic, the method comprising the steps of:
mixing an extrudable dry powder compound, the compound comprising:
a thermoplastic polymer;
pelletized diatomaceous earth; and
a mechanical blowing agent;
extruding the compound through a die to create a shaped product; and
cooling the product after it is removed from the die.

18. The method of claim 17 wherein the mechanical blowing agent comprises a plurality of expandable microballoons.

19. The method of claim 17 wherein the thermoplastic polymer comprises polyvinyl chloride.

20. The method of claim 17 wherein the step of extruding the compound comprises the steps of melting the compound to a slurry, injecting the slurry into the die, and heating and cooling the slurry in the die.

21. The method of claim 20 wherein the step of cooling the product after it is removed from the die comprises passing the product through a cold water bath.
